(19) United States
(12) Patent Application Publication
(10) Pub. No.: US 2008/0158221 A1
(43) Pub. Date: Jul. 3, 2008

(54) Liquid crystal display having storage circuit for storing

(75) Inventors: Sai-Xin Guan, Shenzhen (CN); Yi-Yin Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/005,906

(22) Filed: Dec. 27, 2007

(30) Foreign Application Priority Data
Dec. 29, 2006 (TW) 95149689

(51) Int. Cl. G09G 5/00

(52) U.S. Cl. 345/214

(57) ABSTRACT

An exemplary liquid crystal display (20) includes a liquid crystal panel, a driving chip (200) and an external resistor (270). The driving chip is configured for driving the liquid crystal panel. The driving chip includes a storage circuit (210) and a voltage generator (260). The storage circuit includes a memory (240). The external resistor is connected to the storage circuit and the voltage generator. The voltage generator outputs a voltage, the external resistor divides the voltage into a common voltage. The storage circuit transforms the common voltage to a common voltage parameter, and the memory stores the common voltage parameter. The LCD has high reliability.

### FIELD OF THE INVENTION

The present invention relates liquid crystal displays, and particularly to a liquid crystal display having a storage circuit for storing a common voltage parameter.

### GENERAL BACKGROUND

A liquid crystal display (LCD) has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions.

When an LCD works, gradation voltages are applied to pixel electrodes of the LCD, and a common voltage is applied to common electrodes of the LCD. Thus an electric field is generated, and the electric field is applied to liquid crystal molecules of a liquid crystal layer in the LCD. The electric field controls orientations of the liquid crystal molecules. Thereby, pixel regions of the LCD can display light having particular intensities and colors, and the array of light beams produced by the pixel regions forms an image viewed on a screen of the LCD.

If the electric field between the pixel electrodes and the common electrodes continues to be applied to the liquid crystal molecules in the one same direction, the liquid crystal molecules are liable to eventually deteriorate. In order to avoid this problem, gradation voltages that are provided to the pixel electrodes are generally switched from a positive value to a negative value with respect to the common voltage. This technique is referred to as an inversion drive method. However, the inversion drive method needs the common voltage to have a predetermined constant value, in order to prevent the appearance of flickering on the screen of the LCD. Thus, it is important to set a common voltage parameter at the time the LCD is produced in the factory.

Referring to FIG. 2, a typical LCD 10 includes a liquid crystal panel (not shown), a driving chip 100, and an external resistor 170. The driving chip 100 is configured for driving the liquid crystal panel. The driving chip 100 includes a voltage generator 160 and a buffer 110. The external resistor 170 is a variable resistor, which includes a first contact terminal (not labeled), a second contact terminal (not labeled), and a sliding contact terminal (not labeled). The first contact terminal is connected to ground, the second contact terminal is connected to the voltage generator 160, and the sliding contact terminal is connected to the buffer 110.

The voltage generator 160 of the driving chip 100 outputs a voltage to the external resistor 170. The external resistor 170 divides the voltage into a common voltage, by way of adjustment of the sliding contact terminal. The common voltage is provided to the liquid crystal panel via the buffer 110. When the liquid crystal panel achieves a perfect visible display, the position of the sliding contact terminal is fixed. A divided voltage of the external resistor 170 serves as a common voltage of the liquid crystal panel.

However, the position of the sliding contact terminal may be disturbed when the liquid crystal panel is assembled in the factory or sustains collision or shock. When this happens, the common voltage of the liquid crystal panel is changed, and the display of the liquid crystal panel is liable to exhibit flicker. That is, the liquid crystal panel has rather low performance reliability.

What is needed, therefore, is a liquid crystal display that can overcome the above-described deficiencies.

### SUMMARY

In one preferred embodiment, a liquid crystal display includes a liquid crystal panel, a driving chip and an external resistor. The driving chip is configured for driving the liquid crystal panel. The driving chip includes a storage circuit and a voltage generator. The storage circuit includes a memory. The external resistor is connected to the storage circuit and the voltage generator. The voltage generator outputs a voltage, the external resistor divides the voltage into a common voltage, the storage circuit transforms the common voltage to a common voltage parameter, and the memory stores the common voltage parameter.

Other novel features and advantages will become more apparent from the following detailed description when taken in conjunction with the accompanying drawings.

### BRIEF DESCRIPTION OF THE DRAWINGS

FIG. 1 is a circuit diagram of a liquid crystal display according to an exemplary embodiment of the present invention.

FIG. 2 is a circuit diagram of a conventional liquid crystal display.

### DETAILED DESCRIPTION OF PREFERRED EMBODIMENTS

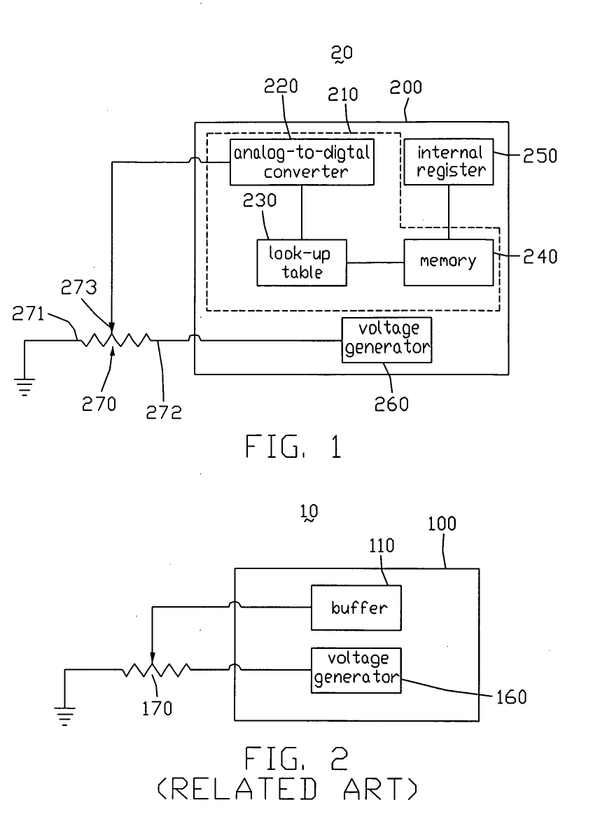

Referring to FIG. 1, a liquid crystal display 20 according to an exemplary embodiment of the present invention is shown. The liquid crystal display 20 includes a liquid crystal panel (not shown), a driving chip 200, and an external resistor 270. The driving chip 200 is configured for driving the liquid crystal panel.

The driving chip 200 includes a voltage generator 260, an internal register 250, and a storage circuit 210. The storage circuit 210 includes an analog-to-digital converter 220, a look-up table 230, and a memory 240. The analog-to-digital converter 220 is connected to the look-up table 230. The memory 240 is connected to the look-up table 230. The internal register 250 is connected to the memory 240.

The external resistor 270 is a variable resistor, which includes a first contact terminal 271, a second contact terminal 272, and a sliding contact terminal 273. The first contact terminal 271 is connected to ground, the second contact terminal 272 is connected to the voltage generator 260, and the sliding contact terminal 273 is connected to the analog-to-digital converter 220 of the storage circuit 210.

A common voltage parameter setting process in accordance with an exemplary embodiment of the present invention is as follows. The voltage generator 260 of the driving chip 200 outputs a voltage to the external resistor 270. The external resistor 270 divides the voltage into a common voltage by adjustment of the sliding contact terminal 273. The common voltage is provided to the analog-to-digital converter 220. The analog-to-digital converter 220 transfers the common voltage to a digital signal, and provides the digital signal to the look-up table 230. The look-up table 230 outputs a corresponding common voltage parameter according to the digital signal to the memory 240. The memory 240 stores the received common voltage parameter. The internal register 250 reads the common voltage parameter from the memory 240, and provides a common voltage to the liquid crystal panel according to the common voltage parameter. The external resistor 270 is adjusted to make the liquid crystal panel achieve a perfect visible display (or at least an optimized display). When the liquid crystal panel achieves the perfect visible display, the common voltage parameter is stored in the memory 240 as read-only data. Thereafter, even if a position of the sliding contact terminal 273 is disturbed or changed, the original optimum common voltage parameter remains stored in the memory 240.

Unlike with a conventional LCD, the common voltage parameter of the LCD 20 cannot be changed even if the position of the sliding contact terminal 273 is changed. Thus, the LCD 20 has a stable common voltage so that any flicker of the LCD 20 is absent (or minimal) at all times. Therefore, the LCD 20 has high performance reliability.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape and arrangement of parts within the principles of the invention to the full extent indicated by the broad general meaning of the terms in which the appended claims are expressed.

What is claimed is:

1. A liquid crystal display comprising:
a liquid crystal panel;
a driving chip configured for driving the liquid crystal panel, the driving chip comprising a storage circuit and a voltage generator, the storage circuit comprising a memory; and
an external resistor connected to the storage circuit and the voltage generator;
wherein the voltage generator outputs a voltage, the external resistor divides the voltage into a common voltage, the storage circuit transforms the common voltage to a common voltage parameter, and the memory stores the common voltage parameter.

2. The liquid crystal display as claimed in claim 1, wherein the driving chip further comprises an internal register, the internal register being configured for outputting a common voltage to the liquid crystal panel according to the common voltage parameter stored in the memory.

3. The liquid crystal display as claimed in claim 2, wherein the storage circuit further comprises an analog-to-digital converter and a look-up table, the analog-to-digital converter being connected to the external resistor, and the analog-to-digital converter transforms an analog common voltage to a digital signal and provides the digital signal to the look-up table, and the look-up table provides the common voltage parameter to the memory according to the digital signal.

4. The liquid crystal display as claimed in claim 1, wherein the common voltage parameter is selectably stored in the memory as read-only data.

5. The liquid crystal display as claimed in claim 1, wherein the external resistor is a variable resistor.

6. The liquid crystal display as claimed in claim 5, wherein the external resistor comprises a first contact terminal, a second contact terminal and a sliding contact terminal, the first contact terminal being connected to the ground, the second contact terminal being connected to the voltage generator, and the sliding contact terminal being connected to the storage circuit.

7. A liquid crystal display comprising:
a liquid crystal panel;
a driving chip provided on the liquid crystal panel, the driving chip comprising a storage circuit; and
an external resistor connected to the storage circuit;
wherein the driving chip outputs a voltage, the external resistor adjusts the voltage to a common voltage, and the storage circuit transforms the common voltage to a common voltage parameter and stores the common voltage parameter.

8. The liquid crystal display as claimed in claim 7, wherein the driving chip further comprises a voltage generator, the voltage generator being connected to the external resistor.

9. The liquid crystal display as claimed in claim 8, wherein the driving chip further comprises an internal register, the internal register outputting a common voltage to the liquid crystal panel according to the common voltage parameter stored in the memory.

10. The liquid crystal display as claimed in claim 9, wherein the common voltage parameter stored in the storage circuit is read-only data.

11. The liquid crystal display as claimed in claim 9, wherein the storage circuit comprises an analog-to-digital converter, a look-up table, and a memory, the analog-to-digital converter being connected to the external resistor, the analog-to-digital converter transforming an analog common voltage to a digital signal and providing the digital signal to the look-up table, and the look-up table providing the common voltage parameter to the memory according to the digital signal.

12. The liquid crystal display as claimed in claim 11, wherein the driving chip further comprises a voltage generator, the voltage generator being connected to the external resistor.

13. The liquid crystal display as claimed in claim 7, wherein the external resistor is a variable resistor.

14. The liquid crystal display as claimed in claim 13, wherein the external resistor comprises a first contact terminal, a second contact terminal and a sliding contact terminal, the first contact terminal being connected to the ground, the second contact terminal being connected to the voltage generator, and the sliding contact terminal being connected to the storage circuit.

15. The liquid crystal display as claimed in claim 14, wherein the external resistor is used to divide a voltage from the voltage generator into the common voltage.
